(19) United States
(12) Patent Application Publication
(10) Pub. No.: US 2004/0006489 A1
(43) Pub. Date: Jan. 8, 2004

(54) Benefits services payment and credit system

(76) Inventor: Douglas B. Bynon, Orange, CA (US)

Correspondence Address: William C. Cray, Esq., Suite A, 414 West Fourth Street, Santa Ana, CA, 92701, US

(21) Appl. No.: 10/189,699

(22) Filed: Jul. 3, 2002

(51) Int. Cl. G06F 17/60

(52) U.S. Cl. 705/2

(57) ABSTRACT

A combined benefits service claim payment and credit system is disclosed which may comprise: a transaction processor, which may be in immediate communication with a benefits service provider over a communication link for receipt of information from the service provider in real time regarding a benefits service recipient and benefits service provided or to be provided. The transaction processor also may be in immediate communication with a claim payer over a communication link for the transmission of information in real time to the payer relating to the service recipient, the service provider and the to be provided service or provided service and for receipt in real time of confirmation of coverage and the amount of coverage. The transaction processor further may be in immediate communication with a benefits service credit provider for transmitting to the credit provider in real time information regarding the service recipient and a required amount of credit needed and for receiving from the credit provider in real time information regarding the availability of that amount of credit for the service recipient. The transaction processor in response to the information received from the payer and from the credit provider may transfer in real time to the service provider funds available to or notification of funds available to the service provider, from either or both of the payer and credit provider, and may provide the service provider and the service recipient with a respective statement memorializing the benefits service payment transaction. The credit provider may provide the service recipient with a statement memorializing the credit transaction. The respective statements may memorialize the service payment transaction and the benefits service credit transaction may be a part of a statement periodically provided and including, if applicable, the memorializing of other similar transactions. The service provider may receive information from the service recipient from an identification token issued to the service recipient by the service credit provider, the payer or the transaction processor.

### FIELD OF THE INVENTION

The field of this invention relates to the process for the coverage of payment and delivery of payment for the provision of health care and related types of services in order to simplify the determination of coverage and the settlement of the payment for the provision of the health care or the like services.

### BACKGROUND OF THE INVENTION

Over a good portion of at least the last forty years government, employers and employee organizations have taken a somewhat paternalistic approach to the provision of health care benefits and for the concomitant payment for the provision of such services and other financial security aspects of employment benefits. The care recipient/patient/employee as a consumer of the care services has been removed from the participation in and even knowledge of the details of the financial settlement of the costs of the provision of such types of care to the care recipient/patient/employee as the consumer. Such care can be things like simple doctor's office visits, diagnostic tests, physical and other examinations, hospitalization, physical therapy, long term disability, elderly assisted care and the like, and in some plans vision related care and dental related care may be the subject of such provided care as well. The process has become fragmented, overly complex and burdensome on all parties concerned, the care recipients, the care providers, the employers and employee representatives, including labor unions and also the providers of the insurance coverage and the financial transactions needed to complete payments for covered services once performed for covered care recipients.

It is widely believed, however, that to provide these kinds of covered services and other personal financial stability security benefits for employees, e.g., against health care costs, retirement, disability to work and even death, generates good will among employees, both toward the employer and the employee representatives, e.g., labor unions. This can very well contribute to employee productivity and retention as the security provided to the employees in these matters promotes moral and longevity, both health-wise and employment-wise. Thusly, employees and even non-employees covered as dependents or individually covered apart from employment benefits may be spared the burden of directly paying for or even being concerned about paying for or even having to bear the financial risk of illness, disability, retirement or even death.

This has, however, led to numerous ill effects. Most care recipients/patients/consumers unrealistically lack the recognition of the amount of the costs of the provision of medical services and the operation of the institutions involved in such provision and in the settlement of the payments in health care transactions. Because fees in the field of the provision of cares services, e.g., health care services, are being more and more paid by insurance carriers, managed care organizations and governmentally funded or partly funded programs, and where fee/dues are often also paid partly of fully by employers, the health care consuming public has a very poor understanding of the true costs of health care and the like kind of benefits.

All transactions for the provision of services that may be the subject of a benefit that the recipient is entitled to for payment for some or all of such services, e.g., health care services can require the pre-determination of some or all of the financial responsibility and the arrangement for the settlement by payment for the costs of and/or the fees for the transaction associated with the rendering of such services. They all also require in some fashion or another the reporting of the transactions to interested parties, government agencies, and the like concerned with the rendering, receipt and responsibility for the payment for the transaction. Payments, in many instances, e.g., health care payments have evolved from the recipient, e.g., the patient, being the primary payer top various combinations of systems where the government, private insurers, etc. or combinations thereof, are the primary payer and further into systems such as managed care systems where the owner of the managed care system is the primary payer. Benefits like the above, e.g., health insurance and other similar forms of indemnifications have become an integral part of a compensations package for an employee, including part-time employees, hourly employees and salaries management up through the highest levels. Fueled by such things as favorable tax treatment and significant increases in costs of the provision of certain kinds of services, e.g., health care services, and such societal and technological factors as the more prolific availability of life-extending treatments and medications, financial security for the payment for the costs of such services has gradually migrated to payers other than the recipient of the service, e.g., the health care service.

As health and other benefit costs have increased over time, especially in the last ten years, sharp increases in the expense and administration of providing these benefits and services as a financial security benefit have diminished the desire of employers to pay for the benefits and of employee representatives, e.g., labor unions to weight them heavily in negotiations with employers over wages and benefits. The employers and labor organizations realize that bearing these tangible costs in return for intangible employee loyalty is an increasingly risky proposition in changing economies, whether improving or deteriorating.

Because employers and government programs have paid the premiums and insurers and HMO's, e.g., paid the care provider directly, the health care consumer/patient has been removed from the financial loop. Other than a small fee per the provision of certain kinds of covered services/benefits in the form, e.g., of a co-payment to the care provider directly, and a small deduction in monthly wages, the care services consumer/patient increasingly has no concept of the true cost of the providing of the services, e.g., the office visit, lab test, prescription or other benefit. The simple transaction where the care provider, e.g., general practice physician at the routine office visit, renders the care services and collects the full fee for doing so from the consumer/patient directly hardly exists any more. In this significant portion of the economy the parties to the service are very minor parties to the financial settlement of the claim transaction for payment for the services.

Currently the financial transaction involved for the obtaining of the provision of services for covered benefits, e.g., health care services, e.g., a routine physician office visit, remains a cumbersome, and most would say dreaded process, for care provider and care service consumer alike. Financial responsibility of the consumer/patient is determined by a care provider, e.g., a doctor's office, by having a consumer/patient initially complete a written form including, e.g., several pages of general information about the patient's background and including the covered benefits provider responsible for paying for the rendering of the, e.g., medical care services. The care provider usually requires the presentation of an identifying card that identifies the care recipient/patient/consumer as covered for certain types of benefits and the entity that is providing such coverage for the provision of the services.

A photocopy of the card, usually front and back, is then taken and the identified insurance or other benefit payment provider is contacted, often initially by phone and then by mail or FAX for the verification of the kind and amounts of coverage and also for whatever formulas there are for such things a deductibles and co-payments. After the provision of the care services, e.g., the examination at the office visit and the provision of medical advice, prescriptions for medication, etc., the consumer/patient is asked to make the co-payment, or the care provider's office may agree to bill the amount due, for later payment to the care provider's office by the consumer/patient.

The actual claim for reimbursement of the main portion of the payment for the rendering of the services is then made to the coverage claims payer, i.e., the insurance company, the managed care provider, the governmental agency, etc. That entity then processes the claim to determine what it believes is due to the care service provider of the care benefit and any applicable deductibles or caps and co-payments and the like, and then pays the amount determined to be due to the care provider, e.g., to the doctor's office, e.g., some amount for the particular care services set by the claim payer and less any deductions, co-payments or the like. This assumes that the care provider has complied with all of the paper-work requirements of the coverage claims payer or managed care provider in regard to the rules to be followed in providing the services and in making the claim.

The care provider, e.g., the doctor's office, must then subsequently reconcile the amount received in reimbursement from the claims coverage payer and the amount received directly from the consumer/patient in the way, e.g., of a co-payment, and then bill the consumer/patient for the amount due, either because the consumer/patient was not required initially to pay the co-payment and/or the care coverage payer did not pay the full amount which represents the difference between the amount sought to be reimbursed and the co-payment, for whatever reason the claim coverage payer or the managed care provider decided not to do so.

Upon receipt of the bill from the care provider, the consumer/patient must then reconcile the amount due to the care provider, e.g., the doctor, with the amount the customer/patient believes to be due from the customer/patient according to the responsibility of the customer/patient under the coverage provided by the respective benefits package or insurance policy or the like, and the amount so far paid to the care provider, e.g., the doctor's office. The consumer/patient, therefore, must attempt to match the bill from the doctor and the explanation of coverage, or rather lack thereof, from the care benefits claims payer. If any difference of opinion has occurred, or the care benefit claims payer paid inaccurately, or any other reason for a discrepancy, the consumer/patient is left to contact the claims benefit payer and care provider for clarification/correction. In the meantime, the care provider is still expecting prompt payment from the consumer/patient.

It is apparent that this process can be convoluted and complex, since a national single payer system is politically not a likelihood in the near future, multiple payer sources will continue to exist for each service provision transaction, even a simple as a doctor's office visit, a lab test or the filling of a prescription.

Of the some $1.2 trillion dollars spend annually for the provision of health care, as an example, approximately 23%, i.e., $276 billion goes to small but frequently repeated transactions such as a routine visit to a doctor's office. There are around three quarters of a trillion doctor's office visits in a given year, and the number is rapidly increasing year to year, and this is particularly so as the baby boomers move towards retirement age. The health care provision market is projected to reach over $2 trillion in the next five years or so. It is estimated that almost 95 million hospital emergency room visits were made in 1999. Some approximately eight million hospital outpatient visits were made in 1997. These numbers continue to grow. The flexibility and security of having access to the payment system according to an embodiment of the present invention will enable millions to be assured that an accident while away from home on business or vacation or the like will not jeopardize prompt care or like inconveniences or threats to the health and well being of the card possessor and his or her family members.

Legal mandates and technological advances have resulted in some developments that coordinate verification and settlement of certain aspects of payer transactions, e./g., by electronic means, which can improve certain aspects of the presently existing systems, e.g., in the health care payment process. However, there is still a need to provide a more comprehensive financial settlement processing system, applicable to a variety of benefits related care service providing, e.g., health care benefits services to handle the expenses of the care provision, there is a need to consolidate the rendering of the transaction completely between the service provider and the service recipient, e.g., through a single or consolidated source. There is a need, e.g., to integrate into the payment process through the service provider the payment of the care service recipient's portion of the payment through, e.g., a unified system of settlement of the payment for the service provision transaction.

### SUMMARY OF THE INVENTION

A combined benefits service claim payment and credit system is disclosed which may comprise: a transaction processor, which may be in immediate communication with a benefits service provider over a communication link for receipt of information from the service provider in real time regarding a benefits service recipient and benefits service provided or to be provided. The transaction processor also may be in immediate communication with a claim payer over a communication link for the transmission of information in real time to the payer relating to the service recipient, the service provider and the to be provided service or provided service and for receipt in real time of confirmation of coverage and the amount of coverage. The transaction processor further may be in immediate communication with a benefits service credit provider for transmitting to the credit provider in real time information regarding the service recipient and a required amount of credit needed and for receiving from the credit provider in real time information regarding the availability of that amount of credit for the service recipient. The transaction processor in response to the information received from the payer and from the credit provider may transfer in real time to the service provider funds available to or notification of funds available to the service provider, from either or both of the payer and credit provider, and may provide the service provider and the service recipient with a respective statement memorializing the benefits service payment transaction. The credit provider may provide the service recipient with a statement memorializing the credit transaction. The respective statements may memorialize the service payment transaction and the benefits service credit transaction may be a part of a statement periodically provided and including, if applicable, the memorializing of other similar transactions. The service provider may receive information from the service recipient from an identification token issued to the service recipient by the service credit provider, the payer or the transaction processor.

### BRIEF DESCRIPTION OF THE DRAWING

FIG. 1 shows a block diagram of an embodiment of a system according to the present invention;

FIG. 2 shows a block diagram of a modification of the embodiment of a system according to the present invention as shown in FIG. 1; and,

FIG. 3 shows a block diagram of another modification of the embodiment of a system according to the present invention as shown in FIG. 1.

### DETAILED DESCRIPTION OF THE PREFERRED EMBODIMENT

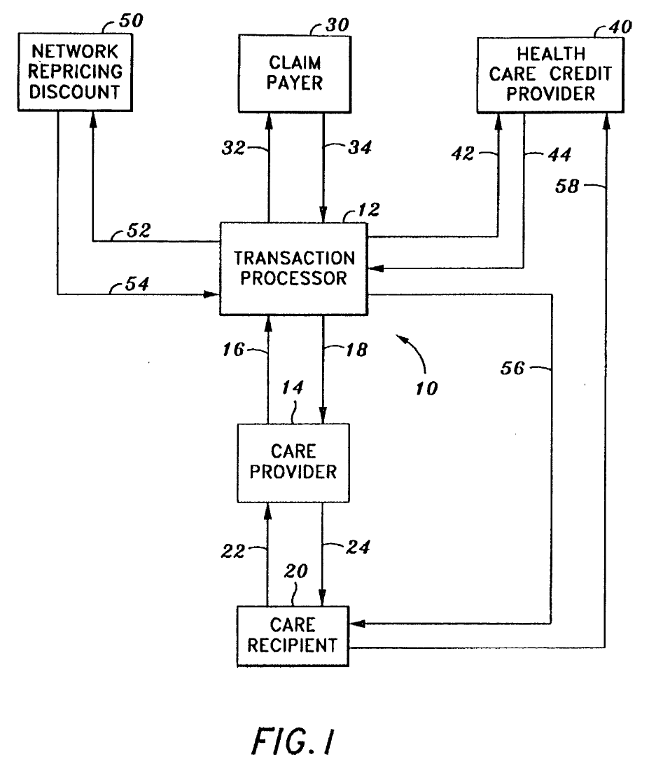

The described embodiment of a system 10 according to the present invention can utilize a credit transaction processor 12 to process transactions between a care provider 14 for the provision of care services and a care recipient 20 in the form of a consumer/patient. In addition, there may be involved a claim payer 30, which may be in the form of an insurance company, a governmental agency, a managed care provider, a self-insured employer, or the like, having a set of members that are authorized to obtain the provision of care services of a particular type from a care provider 14, such as the care recipient 20 illustrated by FIG. 1. The system 10 may also have a network repricing discount entity 50 and a care credit provider 40.

In an embodiment of a system according to the present invention, e.g., as shown illustratively in FIG. 1 there can be a care provision transaction between the care provider 14 and the care recipient 20, in the course of which there can be a communication link 22 established from the care recipient 20 to the care provider 14. This care recipient 20 to care provider 14 communication link 22 may involve, e.g., the transfer of information from the care recipient 20 to the care provider 14, which may include, e.g., the “swiping” of an identification token, e.g., a card (not shown) having a magnetic strip or other data storage capability built into the identification token, e.g., the plastic credit-card-like identification card. The token/card could include along with basic information about the patient, including medical information utilized to initially begin the provision of care and records of care provided such as records of visits, test results records, and the like, according to the available memory.

The card and the information transfer to and from the card can be integrated to the care provider's own electronic data storage and manipulation capabilities. In addition, the card could include some identification and security information such as cornea prints, fingerprints or the like to be compared with the bearer by using the selected form of bio-metric ID verification. Finally the card may include identification of a care service expense claim payer 30, and information for the claim payer 30 to verify participation by the care recipient 20 and for the particular care services, as well as communication links, e.g., Internet web-page addresses, etc. for the care provider 14, or for the care transaction processor 12 to communicate with the claim payer 30 and even for the automatic establishment of such a communication link.

It will be understood by those skilled in the art that the communications links discussed herein could be from different pieces of physical equipment in a single room of an office, like a card sweeper, a telephone, a PC and/or a server and a memory storage apparatus, in one or more rooms of a typical doctor's office, or in the various departments of a hospital, or between buildings on a single campus or even remotely spread out in different cities or different countries. As such they may be of a side variety of links or combinations of links including being in the same computer box, being hard wired together, or communicating over the ordinary public switched telephone network, “PSN,” wireless telephone networks, and other forms of communication networks, e.g., LAN's, WAN's and the like, and including the Internet, and combinations of the above. It will be understood also that these communications by-in-large will be in real time, less any time needed to establish connections over the various elements of the links, as necessary, etc.

In some situations, e.g., a payment by a care recipient 20 to the health care credit provider 40 of the amount due on the monthly statement, while also doable electronically on, e.g., the Internet, or by telephone through telephone check payment or by automatic deduction of funds from an account of the care recipient 20 with some financial institution, including the financial institution that is the health care credit provider 40, may also be by ordinary snail mail.

According to the described preferred embodiments as illustrated in this application, a care provider 14 can pass on to a transaction processor 12 over the care provider 14 to transaction processor 12 communication link 16, sufficient information from the information obtained by the care provider 14 from the care recipient 20 over the care recipient 20 to care provider 14 communication link 22. As noted above, this may be done automatically after the receipt of the information electronically by the care provider 14 from the care recipient 20 over the care recipient 20 to care provider 14 communication link 22. This information may include the identity of a claim payer 30, e.g., the medical claims insurance coverage carrier, the managed health care provider, the government agency and the eligibility of the care recipient 20 for services provided by the care provider 22, and be transmitted over the care provider 14 to transaction processor 12 communication link 16.

The transaction processor 12 can then communicate with the claim payer 30 to verify the current eligibility of the care recipient 20 for payment by the claim payer 30 for the care services rendered or to be rendered by the care provider 14, and including, e.g., any caps, deductibles, co-payments or the like that the care recipient 20 will be responsible for in the completed or contemplated are provision transaction for the services provided or proposed to be provided by the care giver 14 to the care recipient 20. This information may be transmitted by the claim payer 30 to the transaction processor 12 over the claim payer 30 to transaction processor 12 communication link 34.

The transaction processor 12 may also receive over the care provider 14 to transaction processor 12 communication link 16 the identification of the health care credit provider 40 with whom the care recipient 20 is connected as a credit customer, which may be, e.g., a bank in which the care recipient 20 has an account that enables the care recipient 20 to conduct financial transactions and pay on some periodic basis, e.g., monthly, and may be, e.g., an account dedicated solely to care provision services and goods, e.g., health care services and medications or treatments, or may be integrated into a credit card that the care recipient 20 may utilize for other types of purchases as well. It will be understood that the care provider 14 may also have to be a subscriber/member/covered individual to utilized the health care credit provider 40 for these types of transactions which may be different from more ordinary credit purchases of goods/services in that the claim payer 30 is involved and liable for the payment of a significant portion of the amounts due for the services provided, i.e., medical care services. The health care credit provider 40 may also incorporate this service into its usual credit card types of accounts for those also eligible for the health services care credit account services of the health care credit provider 40.

It will be understood that the transaction processor 12 may have to receive another communication from the care provider 14 over the care provider 14 to transaction processor communication link 18 which identifies the actual services provided, e.g., during the provision of health care services in the visit to the doctor's office, e.g., certain types of examinations, tests, diagnostics, procedures, etc. This may also include what the care provider is charging for the services. This charge may be dictated by the claim payer 30 or be capped by the claim payer 30 or may be more than the claim payer 30 is willing to pay for the care recipient 20 to receive the particular form of services from the care provider 14. The information received by the transaction processor 12 from the claim payer 30 over the claim payer 30 to transaction processor 12 communication link 24 may identify any such fixed price or limits of a cap.

The transaction processor 12 may also be in communication with a network repricing/discount entity 50 over a transaction processor 12 to network repricing/discount entity 50 communication link 52 and receive a communication from the network repricing/discount entity indicating the amount to be charged or discounted to the care provider 14 for the participation in the transaction processing system 10 for this particular transaction.

The transaction processor 12 may then communicate to the health care credit provider 40 over the transaction processor 12 to credit provider 40 communication link 42 any amount that the care provider 14 is billing for the provision of the care services to the care recipient 20 and that the claim payer 30 is not going to cover. The health care credit provider 40 may then communicate back to the transaction processor 12 the eligibility of the care recipient 20 for credit in that amount. The claim payer 30 and/or the health care credit provider 40 may then transfer funds to the transaction processor 12 for the purpose of the transaction processor 12 transferring such funds to the care provider 14, over the transaction processor 12 to care provider communication link 18, which may be in the form of some kind of electronic funds transfer to some form of electronic funds “cash register” or other electronic account actually at the care provider 14.

The amount transferred to the health care provider 14 could be less any repricing/discount charge as determined in the network repricing/discount unit 50, based upon information transmitted from the transaction processor 12 over the transaction processor 12 to network repricing/discount unit 50 communication link 52, concerning the nature of the transaction and the participating parties, and communicated to the transaction processor 12 over the network repricing/discount unit 50 to transaction processor 12 communication link 54.

It will also be understood by those skilled in the art that the transaction processor 12 need not be the clearing-house for all communications links between, e.g., the care provider 14 and the claim payer 30 or the health care credit provider 40. For example, the “swiping” of the ID token in the office of the care provider 14 (or other form of reading the electronically stored information) may be directly connected to the heal care credit provider 40 over a communication link (not shown), which in turn, can then verify the available credit for the care recipient 20 to either or both of the care provider 14 and the transaction processor 12. A similar direct communication link (not shown) may be established between the care provider 14 and the claim payer 30.

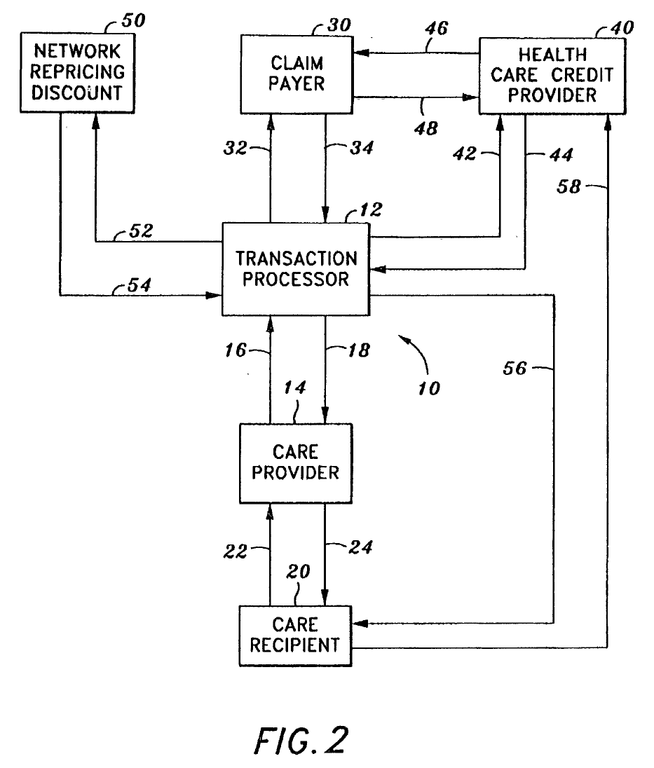

In the embodiment illustrated in FIG. 2, the claim payer 30 may communicate directly with the health care credit provider 40 over a claim payer 30 to health care credit provider 40 communication link 48 to receive a transfer of funds for retransfer to the transaction processor 12 for the particular transaction or to transfer funds to the health care credit provider 40 for the account of the care recipient 20. Also, such funds could then be transferred by the health care credit provider 40 to the transaction processor 12 over the health care credit provider 40 to transaction processor 12 communication link 44. In addition to passing information to the transaction processor 12 concerning the credit transaction over the health care credit provider 40 to transaction processor 12 communication link 44, the health care credit provider may also transmit funds electronically to the transaction processor 12.

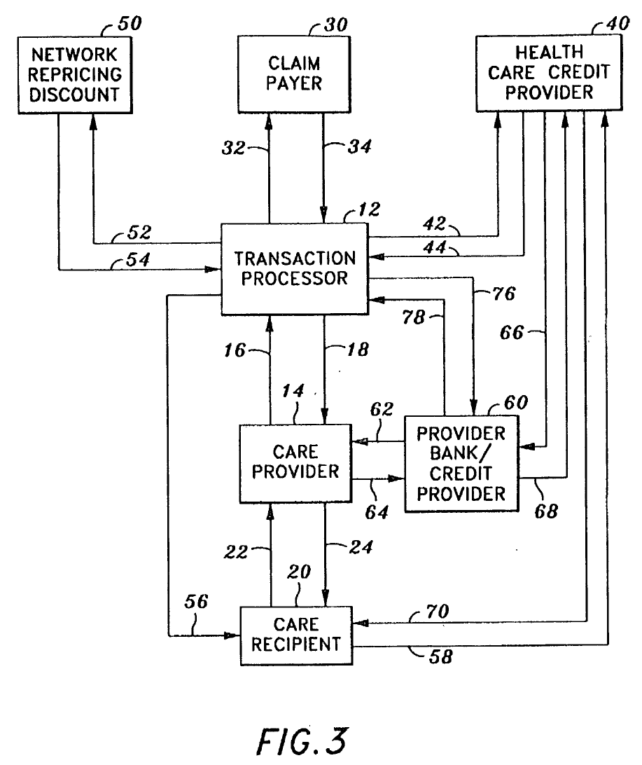

Turning now to FIG. 3, there is shown another embodiment of a system 10 according to the present invention as illustrated in FIG. 1. In this embodiment, the care provider 14 may have a care provider bank or credit provider 60, which may be connected to the care provider 14 by a care provider 14 to care provider bank/credit provider 60 communication link 64 and a care provider bank or credit provider 60 to care provider 14 communication link 62. The care provider bank or credit provider 60 may also be connected to the health care credit provider 40 by a health care credit provider 40 to care provider bank or credit provider 40 communication link 66 and a care provider bank or credit provider 60 to health care credit provider 40 communication link 68. The care provider band or credit provider 60 may also be connected to the transaction processor 12 by a transaction processor 12 to care provider bank or credit provider 60 communication link 76 and by a care provider bank or credit provider 60 to transaction processor 12 communication link 78.

In the embodiment of FIG. 3, the transaction processor 12 may transfer the funds associated with the claim payer 30 to the care provider bank/credit provider 60 for utilization by the care provider 14, e.g., the care provider 14 may have an account with the care provider bank or credit provider 60 or a credit arrangement or both. In addition, the health care credit provider 40 may transfer funds to the care provider bank or credit provider 60 for the utilization of the care provider 14. In this embodiment, the care provider 14 may receive a single statement, e.g., from the transaction processor 12 or the care provider bank or credit provider 60 or may receive statements from both or may also receive a statement from the health care credit provider 40, which may in turn come through either the transaction processor 12 or the care provider bank or credit provider 60.

It will be understood by those skilled in the art that there are many combinations and permutation of the elements of the system of the present invention, illustrated by way of examples in the embodiments of FIGS. 1-3. For example, the functionalities described may be collapsed into single or related entities, e.g., into related corporate entities or operational units of a single corporate entity. By way of example, the health care credit provider 40 and the care provider bank or credit provider 60 may be the same financial institution or related parts (e.g., separate related corporations or operating units within a corporate entity). As another example, the claim payer 30 and the health care credit provider 40 may be the same entity or similarly related entities.

In addition, the transaction processor 12 and the claim payer 30 could be the same entity or similarly related entities. Further, the transaction processor 12 and the network repricing/discount unit could be the same or similarly related entities. In fact, the entire system of the present invention, e.g., except the care provider 14 and the care provider's bank or credit provider 60 can be the functioning of a single entity or similarly related entities. For example, a large medical claims insurer may at the same time act as the claim payer 30, the transaction processor 12 and the network repricing/discount unit 50 and may even have within it a financial institution that can act as the health care credit provider 40, or at least that single entity combining the functions of transaction processor 12, claim payer 30 and network pricing/discount unit 50 may also have a bank or credit provider that acts as the health care credit provider 40, though an unrelated corporate entity.

This may be an exemplar for the operation of a system according to the present invention in the environment of the small to medium sized care provider, e.g., a doctor's office with a sole practitioner or up to several doctors. This model may also fit for a managed health care operation and a large number of separate care providers 14 and perhaps their own banks or credit providers 60, or alternatively wherein the individual care providers 14 simply receive a statement from and a payment check periodically from the managed care organization. In such an operation, the health care credit provider 40 may be separate from the managed care operation and instead of sending the credit portion of the payment for the care service provided to the care provider 14 or the care provider bank or credit provider 60 may send the funds to the managed care organization for subsequent including in a periodic payment to the care provider 14. However, it will be understood that this is still a transfer making the funds available for the utilization by the care provider 14 in return for the care service provided, just as if transferred by the health care credit provider 40 directly to the care provider 14 or the care provider bank or credit provider 60.

Another example may be that a large private or governmental employer may establish itself as a claim payer 30 for its employees as care recipients 20 from selected care providers 14 and act also as the transaction processor 14 and network repricing/discount unit 50 and may even also act as the health care credit provider 40 or have its bank act as the health care credit provider 40 or may deal with an unrelated entity acting as the health care credit provider 40. In such an environment the employer may issue the care recipient identification tokens. In addition it may reduce the costs of providing health benefits to the employees by itself obtaining the benefit of the repricing/discount charge to the care provider 14 for operating the system and the interest on the credit provided to the care recipient/employee. The health care credit provider 40 could be, e.g., a corporate or governmental entity employee credit union.

It will also be understood that the functionalities of the entities of the system according to the illustrated embodiments of the invention could be exploded out. For example, though not shown, the transaction processor 12 and/or the claim payer 30 and/or care recipient 20 may have associated with it a separate bank or like financial institution, e.g., for accepting and issuing funds transfers, including electronic funds transfers, according to the operation of the present invention.

These and other possible modifications to the embodiments of the present invention will be well understood by those skilled in the art and form a part of the invention as recited in the claims below.

It can be seen that in operation the present invention not only simplifies the entire process and streamlines its operation in time and effort, it also brings the financial transaction back to the care provider and the patient/customer level. It relieves the need for much of the massive processing of paper records for processing care provider claims for reimbursement from those covering the patient/consumer. It makes even more effective and efficient such technologies as electronic transfer of funds as applied presently in the financial settlement side of the payment for the provision of care services and like provision of services. It provides a simplified and unified settlement of a health care financial transaction at the point of service provision. According to an embodiment of the present invention all payer transactions can be aggregated, processed, settled and reported by a transaction system processor, which may be a transaction processing system operator or controlled by a transaction processing system operator. This can replace aspects of the current system wherein the aggregation at the point of service is the burden and responsibility of the service provider. The system of an embodiment of present invention as disclosed may combine several existing activities and technologies in a manner not presently aggregated. The system can cross-utilize technologies and processes in a manner that simplifies the process of establishing, fulfilling and reporting financial responsibility for a benefits provision transactions, e.g., a health care service provision transaction.

This hugely benefits a section of the economy that before the invention of the present application was probably one of the largest utilizers of the archaic technologies of processing transactions such as this almost entirely in paper records and in temporal spans of days or weeks. In addition even where the systems of the past were utilizing electronic communication, data processing and record keeping/accessing and manipulating, these developments largely were in the sphere of the care provider and the insurance claims coverage payer/managed care compensator. The present invention in operation brings the fundamental transaction for the obtaining and payment for the provision of services and benefits, e.g., health care services, back to the level of the care provider and the care recipient.

It will be further understood by those skilled in the art that the present invention can serve to resolve the entire financial transaction relating to the provision of care services, e.g., a doctor's office visit via a single credit-card like transaction. Payment can be made completely and near immediately. The verification process time and labor expenditure is virtually eliminated. The care provider can receive periodic reports, statements and the like consolidating all payment transactions, and this may even be integrated into the care provider's own accounting or office management software program or its own bank statements. Payments can be made electronically for all aspects of the financial transaction involving the consumer/patient and the claims payment payer and the care credit provider. The statements and reports can be of the type that a merchant receives from credit card companies with which it deals for transactions involving the holders of such cards. The care provider may even verify availability of funds for the entire payment for the care service to be rendered prior to the rendering of the service and have the funds in hand or in its bank account before the provision of the services, or at least, e.g., at the press of a button or click of an icon or the like as soon as the patient is ready to leave the care provider's office. At least the care provider can be informed in real time as to what will and will not be covered in the financial transaction and have the option to charge the patient accordingly at the office of the care provider or bill the recipient later.

The service recipient, e.g., patient, in turn, according to an embodiment of a system according to the present invention, may simplify the process for the obtaining of care services. This consumer purchaser/recipient of the benefit services, e.g., health care services may also be a person responsible in the traditional system sense for the payment for the service, e.g., the parent of a covered person receiving covered health care benefits. In addition, the patient may also receive a monthly statement summarizing all transactions involving provision of care services. The statement can be in a familiar credit card statement format and the consumer/patient may have the ability to pay once monthly for all services involving the provision of, e.g., health care services, or even spread payments out over several months in the manner of interest bearing credit payments. The claims payer can have consolidated transactions with its payments batched by the transaction processor. Routine auto-adjudicated claims need not be adjudicated. The claims payer can make periodic electronic transfers to the transaction processor or its bank or in some embodiments can transfer funds to the credit provider or even to the bank of the care provider.

The care credit provider can have a profitable book of credit paper, which can be of a category that is more easily discounted or otherwise liquidized because of the high portion of the payments coming from insurance companies and government agencies and because of the fact that medical care is considered a financial necessity by most of the consuming public, particularly working consumers.

The transaction processor can benefit much from the transaction charges to the health care provider, i.e., the doctor or other care service provider in the position essentially of a credit purchase merchant, and the float on any monies collected from the claim payer prior to payment to the care provider or other financial charges, e.g., from the care credit providing bank, and any discounts charged to the care provider for carrying out the credit payment transaction and immediate payment and the ancillary and additional prospective sales of credit and like financial transactional services to, e.g., the care providers and care recipients. The transaction processor and/or the operator of the transaction processor can be other than just an existing configuration of financial transaction processing. The transaction processor can perform a clearing house activity by receiving claims for payment of a benefit, e.g., the provision of health care services, to which the recipient, e.g., a health care service recipient, is entitled, which claims can be received from the benefit service provider, can verify the pre-determined source or sources for payment and/or any existing contractual relationships relating to repricing services, report this information to all concerned parties, collect payments from the appropriate party(ies), and disburse payments to the appropriate party(ies) and report all of the related transactions to the appropriate parties.

Utilizing an embodiment of the system of the present invention it is estimated that a small to medium sized care provider, e.g., doctor's office could operate with one to one and one half less staff persons, virtually eliminate bad-debt write-offs and eliminate long waits in getting payments from the claims payer or the managed care provider. The adoption of an embodiment of the system of the present invention, such as the one described herein, could permit the health care providing professional to engage in the practice of the providing of care, such as health care, with far less concern for the costs and time consumed in the presently employed processes, including such needs as verification of eligibility, submission of claims and reconciliation, billing and collection, this can be applicable to a wide variety of benefits service providers, e.g., in the health care benefit arena alone this system may be utilized, e.g., by a health care professional(s) office, medical laboratory, diagnostic testing facility, e.g., ray or MRI provider, prescription dispenser, hospital, clinic or other enterprise or service relating to the rendering of benefits services of the provision of benefits related products, e.g., in the health care field.

It will further be understood that an embodiment of the system of the present invention could be as easily implement in the environment of publicly funded care provision, such as Medicare, MediCal, Medicaid and other such forms of government assistance. For example, the service provided as opposed to health care, could be insured automobile collision repair, flood relief, supplemental food purchase assistance or the like kinds of privately or governmentally funded provisions of these and like kinds of services and benefits. In addition, the system could be implemented within a single organization or related entities with different departments, subsidiaries or like related legal or operational entities acting as the separate elements described above, e.g., if a managed care provider and its bank wanted to implement an embodiment of the system of the present invention, or if a hospital and its bank wanted to do so, and for example, also wanted to have this kind of a payment relationship with a large employer or labor union or association of lawyers, fire fighters, policeman, etc.

An embodiment of the system of the present invention could also easily be utilized for such activities as emergency room visits, out-patient walk in facilities, physical therapy, etc.

A system according to the present invention, e.g., as disclosed in the preferred embodiments, can, therefore, include the submission of financial transaction information from a service provider, e.g., by electronic means to a transaction processor, e.g., through existing credit card verification and approval mechanism and machines as is known in the art of electronic credit card transaction processing, or over the internet in a web-bases transaction type of process, or through an interactive voice/data response process, e.g., over a touch tone telephone, or other similar related mechanisms. The transaction processor can aggregate payer sources for the particular care recipient according to data relating, e.g., to the recipients eligibility for one or more such payment plans applicable to the services/products provided. These can include an inseminator in the form, e.g., of a health insurance company, a managed health care organization, a self-funded trust, a government agency, or other such risk transfer entities/mechanisms, or it could include a discounting functionary which, e.g., re-process the transaction between payers and service providers according to the terms of some pre-arranged re-pricing agreement, e.g., as between the provider and a Re-Pricing contract Administrator, or it could involve a pre-tax health care payment account which, e.g., holds funds of the recipient, and it could also involve a credit provider with a pre-determined arrangement to fund the payment of any balance due to the care provider after the other payments from the other payer(s) have been remitted and their liability is exhausted for the particular transaction.

The transaction processor may utilize, e.g., the system of Electronic Data Information Exchange provided for in existing health care payment systems as mandated by the Health Insurance and Patient Portability Administration Act, to verify eligibility for funding all or part of the health care transaction and the amount of re-pricing from a re-pricing contract administrator, if such re-pricing is not pre-calculated in the amount authorized for payment by the payer. Upon verification of eligibility of funding for the transaction the transaction processor can utilize, e.g., automate Adjudication of Claims arrangements with such payer(s) to fund the transaction up to the extent of eligibility according to the arrangement between the care service recipient and the payer(s).

Remaining amounts, which have traditionally been labeled “Patient Portion” or “Patient Obligation,” can then be funded, e.g., to the transaction processor by, e.g., the health care credit provider and/or the medical savings account or the like. The transaction processor then can provide for the settlement of the health care transaction to the service provider, e.g., by crediting the account of the health care service provider and then providing a report of the settlement with the health care service provider, e.g., through electronic mail or the like or through more traditional hard copy notification on such vehicles as bank statements went by snail mail or some combination of both. The transaction processor may also then report, e.g., by a consolidated report periodically to the care recipient, e.g., monthly, with a report of all relevant transactions, including, e.g., the amounts paid to the service provider(s) and the amounts covered by any benefits payer(s), and also indicate, e.g., the extension(s) of credit for any of the transactions for patient obligations paid from the accounts of the credit provider. In addition, the care recipient may receive additional statements, e.g., from the health care credit provider indication extensions of credit and related credit information, including the obligations of the care recipient according to the arrangement between the care recipient and the credit provider, e.g., for interest and other fees. This may also include, if the account is, e.g., a revolving credit arrangement, the minimum amount due from the care recipient if the care recipient is to stretch the payments over several payment periods, according also to the applicable laws governing such credit extension transactions.

The above noted and other modifications and changes to the system and method of the present invention would be well known to those skilled in the art and would not depart from the scope and intent of the present invention and should be considered within the scope and spirit of the literal language of the claims as recited below.

We claim:

1. A combined benefits service claim payment and credit system comprising:
a transaction processor;
the transaction processor being in immediate communication with a benefits service provider over a communication link for receipt of information from the benefits service provider in real time regarding a benefits service recipient and provided benefits service provided or to be provided by the benefits service provider to the benefits service recipient;
the transaction processor also being in immediate communication with a claim payer over a communication link for the transmission of information in real time to the claim payer relating to the benefits service recipient, the benefits service provider and the to be provided service or provided service and for receipt in real time of confirmation of coverage and the amount of coverage;
the transaction processor further being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor in response to the information received from the claim payer and from the benefits service credit provider transferring in real time to the benefits service provider funds available to the benefit service provider or notification of funds available to the benefits service provider, from either or both of the claim payer and benefits service credit provider.

2. The system of claim 1, further comprising:
the transaction processor providing the benefits service provider and the benefits service recipient with a respective statement memorializing the benefits service payment transaction.

3. The system of claim 1, further comprising:
the benefits service credit provider providing the benefits service recipient with a statement memorializing the credit transaction.

4. The system of claim 2, further comprising:
the benefits service credit provider providing the benefits service recipient with a statement memorializing the credit transaction.

5. The system of claim 3, further comprising:
the respective statements memorializing the benefits service payment transaction and the benefits service credit transaction being a part of a statement periodically provided and including, if applicable, the memorializing of other similar transactions.

6. The system of claim 4, further comprising:
the respective statements memorializing the benefits service payment transaction and the benefits service credit transaction being a part of a statement periodically provided and including, if applicable, the memorializing of other similar transactions.

7. The system of claim 5, further comprising:
the benefits service provider receiving information from the benefits service recipient from an identification token issued to the benefits service recipient by the benefits service credit provider, the claim payer or the transaction processor.

8. The system of claim 6, further comprising:
the benefits service provider receiving information from the benefits service recipient from an identification token issued to the benefits service recipient by the benefits service credit provider, the claim payer or the transaction processor.

9. A benefits service transaction payment system comprising:
a benefits service transaction payment processor having an immediate communication link to a benefits service provider for receiving information from the benefits service provider regarding the identity of the benefits service provider, a benefits service recipient, a benefits service provided or to be provided, a charge by the benefits service provider for the benefits service provided or to be provided, a claim payer and a benefits service credit provider;
the benefits service transaction payment processor also having an immediate communication link to the claim payer and the benefits service credit provider for receiving from the claim payer a verification of liability by the claim payer for payment for a first amount equal to some portion or all of the charge by the benefits service provider and for receiving a verification of credit available of a second amount from the benefits service credit provider to the benefits service recipient;
the benefits service payment transaction processor also being adapted to provide to the benefits service provider over an immediate communication link the first amount and/or the second amount available to the benefits service provider or the verification of availability of the first amount and the second amount for payment for the benefits service provided.

10. The system of claim 9, further comprising
the benefits service transaction payment processor being adapted to provide a statement to the benefits service provider memorializing the benefits service payment transaction.

11. The system of claim 9, further comprising:
the benefits service transaction payment processor being adapted to receive from the benefits service provider information relating to the benefits service recipient obtained from the benefits service recipient by the benefits service provider from data stored electronically on an identification token issued to the benefits service recipient by the claim payer, the benefits service credit provider or the benefits service transaction payment processor.

12. A combined benefits service claim payment and credit system comprising:
a transaction processor means;
the transaction processor means including means for being in immediate communication with a benefits service provider over a communication link for receiving information from the benefits service provider in real time regarding a benefits service recipient and provided benefits service provided by or to be provided by the benefits service provider to the benefits service recipient;
the transaction processor also including means for being in immediate communication with a claim payer over a communication link for transmitting information in real time to the claim payer relating to the benefits service recipient, the benefits service provider and the provided service or to be provided service and for receiving in real time confirmation of coverage and the amount of coverage;
the transaction processor means further including means for being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor including means in response to the information received from the claim payer and from the benefits service credit provider for transferring in real time to the benefits service provider funds available to the benefit service provider or notification of funds available to the benefits service provider from either or both of the claim payer and benefits service credit provider.

13. The system of claim 12, further comprising:
the transaction processor means including means for providing the benefits service provider and the benefits service recipient with a respective statement memorializing the benefits service payment transaction.

14. The system of claim 12, further comprising:
the benefits service credit provider having a means for providing the benefits service recipient with a statement memorializing the credit transaction.

15. The system of claim 14, further comprising:
the benefits service credit provider having a means for providing the benefits service recipient with a statement memorializing the credit transaction.

17. The system of claim 15, further comprising:
the respective statements memorializing the benefits service payment transaction and the benefits service credit transaction forming a part of a statement periodically provided and including, if applicable, the memorializing of other similar transactions.

18. The system of claim 16, further comprising:
the benefits service provider including a means for receiving information from the benefits service recipient from an identification token issued to the benefits service recipient by the benefits service credit provider, the claim payer or the transaction processor.

19. The system of claim 17, further comprising:
the benefits service provider including a means for receiving information from the benefits service recipient from an identification token issued to the benefits service recipient by the benefits service credit provider, the claim payer or the transaction processor.

20. A benefits service transaction payment system comprising:
a benefits service transaction payment processor means having an immediate communication link means to a benefits service provider for receiving information from the benefits service provider regarding the identity of the benefits service provider, a benefits service recipient, a benefits service provided or to be provided, a charge by the benefits service provider for the benefits service provided or to be provided, a claim payer and a benefits service credit provider;
the benefits service transaction payment processor means also having an immediate communication link means to the claim payer and the benefits service credit provider for receiving from the claim payer a verification of liability by the claim payer for payment for a first amount equal to some portion or all of the charge by the benefits service provider and for receiving a verification of credit available of a second amount from the benefits service credit provider to the benefits service recipient;
the benefits service payment transaction processor means having a means for providing to the benefits service provider over an immediate communication link the first amount and the second amount or a verification of availability of the first amount and the second amount for payment for the benefits service provided.

21. The system of claim 20, further comprising:
the benefits service transaction payment processor means including means for providing a statement to the benefits service recipient memorializing the benefits service payment transaction.

22. The system of claim 20, further comprising:
the benefits service transaction payment processor means including means for receiving from the benefits service provider information relating to the benefits service recipient obtained from the benefits service recipient by the benefits service provider from data stored electronically on an identification token issued to the benefits service recipient by the claim payer, the benefits service credit provider or the benefits service payment processor.

23. A combined benefits service claim payment and credit method comprising:
providing a transaction processor in immediate communication with a benefits service provider over a communication link and receiving information from the benefits service provider in real time regarding a benefits service recipient and provided benefits service provided or to be provided by the benefits service provider to the benefits service recipient;
the transaction processor also being in immediate communication with a claim payer over a communication link and transmitting information in real time to the claim payer relating to the benefits service recipient, the benefits service provider and the provided service or to be provided service and receiving in real time confirmation of coverage and the amount of coverage;
the transaction processor further being in immediate communication with a benefits service credit provider and transmitting to the benefits service credit provider in real time information regarding the benefits service recipient and a required amount of credit needed and for receiving in real time from the benefits service credit provider information regarding the availability of that amount of credit for the benefits service recipient;
the transaction processor in response to the information received from the claim payer and from the benefits service credit provider transferring in real time to the benefits service provider funds available to the benefits service provider or notification of funds available to the benefits service provider from either or both of the claim payer and benefits service credit provider.

24. The method of claim 23, further comprising:
the transaction processor providing the benefits service provider and the benefits service recipient with a respective statement memorializing the benefits service payment transaction.

25. The method of claim 23, further comprising:
the benefits service credit provider providing the benefits service recipient with a statement memorializing the credit transaction.

26. The method of claim 24, further comprising:
the benefits service credit provider providing the benefits service recipient with a statement memorializing the credit transaction.

27. The method of claim 23, further comprising:
the respective statements memorializing the benefits service payment transaction and the benefits service credit transaction forming a part of a statement periodically provided and including, if applicable, the memorializing of other similar transactions.

28. The method of claim 24, further comprising:
the respective statements memorializing the benefits service payment transaction and the benefits service credit transaction forming a part of a statement periodically provided and including, if applicable, the memorializing of other similar transactions.

29. The method of claim 27, further comprising:
the benefits service provider including a means for receiving information from the benefits service recipient from an identification token issued to the benefits service recipient by the benefits service credit provider, the claim payer or the transaction processor.

30. The method of claim 28, further comprising:
the benefit service provider receiving information from the benefits service recipient from an identification token issued to the benefits service recipient by the benefits service credit provider, the claim payer of the transaction processor.

31. A benefits service transaction payment method comprising:
a benefits service transaction payment processor having an immediate communication link means to a benefits service provider and receiving information from the benefits service provider regarding the identity of the benefits service provider, a benefits service recipient, a benefits service provided or to be provided, a charge by the benefits service provider for the benefits service provided or to be provided, a claim payer and a benefits service credit provider;
the benefits service transaction payment processor also having an immediate communication link to the claim payer and the benefits service credit provider and receiving from the claim payer a verification of liability by the claim payer for payment for a first amount equal to some portion or all of the charge by the benefits service provider and for receiving a verification of credit available of a second amount from the benefits service credit provider to the benefits service recipient;
the benefits service payment transaction processor also providing to the benefits service provider over an immediate communication link the first and/or the second amount available to the benefits service provider, or the verification of availability of the first amount and/or the second amount for payment for the benefits service provided.

32. The method of claim 31, further comprising
the benefits service transaction payment processor providing a statement to the benefits service provider memorializing the benefits service payment transaction.

33. The system of claim 32, further comprising:
the benefits service transaction payment processor receiving from the benefits service provider information relating to the benefits service recipient obtained from the benefits service recipient by the benefits service provider from data stored electronically on an identification token issued to the benefits service recipient by the claim payer, the benefits service credit provider or the benefits service payment processor.

34. A combined benefits service claim payment and credit system comprising:
a transaction processor;
the transaction processor being in immediate communication with a benefits service provider over a communication link for receipt of information from the benefits service provider in real time regarding a benefits service recipient and provided benefits service provided or to be provided by the benefits service provider to the benefits service recipient;
the transaction processor also being in immediate communication with a claim payer over a communication link for the transmission of information in real time to the claim payer relating to the benefits service recipient, the benefits service provider and the to be provided service or provided service and for receipt in real time of confirmation of coverage and the amount of coverage;
the transaction processor further being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor in response to the information received from the claim payer and from the benefits service credit provider transferring in real time to the benefits service provider funds available to the benefit service provider or notification of funds available to the benefits service provider, from either or both of the claim payer and benefits service credit provider;
the transaction processor providing the benefits service provider and the benefits service recipient with a respective statement memorializing the benefits service payment transaction.

35. A combined benefits service claim payment and credit system comprising:
a transaction processor;
the transaction processor being in immediate communication with a benefits service provider over a communication link for receipt of information from the benefits service provider in real time regarding a benefits service recipient and provided benefits service provided or to be provided by the benefits service provider to the benefits service recipient;
the transaction processor also being in immediate communication with a claim payer over a communication link for the transmission of information in real time to the claim payer relating to the benefits service recipient, the benefits service provider and the to be provided service or provided service and for receipt in real time of confirmation of coverage and the amount of coverage;
the transaction processor further being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor in response to the information received from the claim payer and from the benefits service credit provider transferring in real time to the benefits service provider funds available to the benefit service provider or notification of funds available to the benefits service provider, from either or both of the claim payer and benefits service credit provider;
the transaction processor providing the benefits service provider and the benefits service recipient with a respective statement memorializing the benefits service payment transaction;
the benefits service credit provider providing the benefits service recipient with a statement memorializing the credit transaction.

36. A combined benefits service claim payment and credit system comprising:
a transaction processor;
the transaction processor being in immediate communication with a benefits service provider over a communication link for receipt of information from the benefits service provider in real time regarding a benefits service recipient and provided benefits service provided or to be provided by the benefits service provider to the benefits service recipient;
the transaction processor also being in immediate communication with a claim payer over a communication link for the transmission of information in real time to the claim payer relating to the benefits service recipient, the benefits service provider and the to be provided service or provided service and for receipt in real time of confirmation of coverage and the amount of coverage;
the transaction processor further being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor in response to the information received from the claim payer and from the benefits service credit provider transferring in real time to the benefits service provider funds available to the benefit service provider or notification of funds available to the benefits service provider, from either or both of the claim payer and benefits service credit provider;
the transaction processor providing the benefits service provider and the benefits service recipient with a respective statement memorializing the benefits service payment transaction;
the benefits service credit provider providing the benefits service recipient with a statement memorializing the credit transaction;
the respective statements memorializing the benefits service payment transaction and the benefits service credit transaction being a part of a statement periodically provided and including, if applicable, the memorializing of other similar transactions.

37. A combined benefits service claim payment and credit system comprising:
a transaction processor;
the transaction processor being in immediate communication with a benefits service provider over a communication link for receipt of information from the benefits service provider in real time regarding a benefits service recipient and provided benefits service provided or to be provided by the benefits service provider to the benefits service recipient;
the transaction processor also being in immediate communication with a claim payer over a communication link for the transmission of information in real time to the claim payer relating to the benefits service recipient, the benefits service provider and the to be provided service or provided service and for receipt in real time of confirmation of coverage and the amount of coverage;
the transaction processor further being in immediate communication with a benefits service credit provider for transmitting to the benefits service credit provider in real time information regarding the benefits service recipient and a required amount of credit needed and for receiving from the benefits service credit provider in real time information regarding the availability of that amount of credit for the benefits service recipient;
the transaction processor in response to the information received from the claim payer and from the benefits service credit provider transferring in real time to the benefits service provider funds available to the benefit service provider or notification of funds available to the benefits service provider, from either or both of the claim payer and benefits service credit provider;
the transaction processor providing the benefits service provider and the benefits service recipient with a respective statement memorializing the benefits service payment transactions,
the benefits service credit provider providing the benefits service recipient with a statement memorializing the credit transaction.
the respective statement memorializing the benefits service payment transaction and the benefits service credit transaction being a part of a statement periodically provided and including, if applicable, the memorializing of other similar transactions;
the benefits service provider receiving information from the benefits service recipient from an identification token issued to the benefits service recipient by the benefits service credit provider, the claim payer or the transaction processor.
